(19) United States
(12) Patent Application Publication
(10) Pub. No.: US 2024/0143640 A1
(43) Pub. Date: May 2, 2024

(54) COMPLIANCE DETERMINATIONS FOR CONVEYANCE OF BENEFITS

(71) Applicant: INTERNATIONAL BUSINESS MACHINES CORPORATION, Armonk, NY (US)

(72) Inventors: Jessica Nicole Ridella, Oakland, CA (US); Anna Kershisnik, Austin, TX (US); Safura Suleymanova, Markham (CA); Breanne Renee Lewis, Ontario (CA); Lazar Glumac, Ontario (CA); Thomas Kahessay, Calgary (CA); Madhurima Dutta, Ontario (CA); Olorunkemi Oluwayemisi Awosanya, Toronto (CA); Jason Andrew Viehland, Sudbury, MA (US)

(21) Appl. No.: 18/051,929

(22) Filed: Nov. 2, 2022

(51) Int. Cl. G06F 16/34; G06F 16/332; G06Q 10/1057

(52) U.S. Cl. CPC G06F 16/345; G06F 16/3329; G06Q 10/1057

(57) ABSTRACT

Compliance determination for conveyance of benefits includes searching for, and downloading, digital compliance material describing relevant compliance policies for conveyance of benefits to a benefit recipient, applying artificial intelligence model(s) to the downloaded digital compliance material, and determining at least one compliance policy for conveyance of benefit(s) to the benefit recipient, based on receiving a prompt from a sender desiring to convey a benefit, responding by indicating, for each identified benefit of at least one identified benefit, whether conveyance of the identified benefit complies with the relevant compliance policies for conveyance of benefits to the benefit recipient.

### STATEMENT REGARDING PRIOR DISCLOSURES BY THE INVENTOR OR A JOINT INVENTOR

The following disclosure(s) are submitted under 35 U.S.C. 102(b)(1)(A):
VIDEO: “Creating a distinctive CX with AI-driven client insight”, Jessica Ridella and Anna Kershisnik, IBM Innovation Day, IBM Expert TV, 10 Nov. 2021, available at: www dot youtube dot com slash watch?v=DYottrc2qHA.

### BACKGROUND

Corporate gifting refers to the conveyance of a benefit on behalf of a company, as the sender, to a recipient of that benefit. Often the conveyance is made from the company, or an employee or associate of the company, and often the benefit is in the form of a gift, amenity, or service provided to or for the recipient. The recipient could be a target company, employee or associate of that target company, an individual, or any other entity. Many companies put into place compliance policies pertaining to conveyance of benefits, and many times a company has compliance policies covering conveyance of benefits by employees/associates to recipients outside of that company as well as compliance policies covering conveyance of benefits by others to the company, employees, and associated thereof, as a recipient of the benefits.

### SUMMARY

Shortcomings of the prior art are overcome and additional advantages are provided through the provision of a computer-implemented method. The method includes automatically searching for, and downloading, digital compliance material. The digital compliance material describes relevant compliance policies for conveyance of benefits to a benefit recipient. The method also includes applying at least one artificial intelligence model to the downloaded digital compliance material, and determining, from the applying the at least one AI model, at least one compliance policy for conveyance of at least one benefit to the benefit recipient. The method further includes, based on receiving a prompt from a sender desiring to convey a benefit, responding by indicating, for each identified benefit of at least one identified benefit, whether conveyance of the identified benefit complies with the relevant compliance policies for conveyance of benefits to the benefit recipient.

Further, a computer system is provided that includes a memory and a processor in communication with the memory, wherein the computer system is configured to perform a method. The method automatically searching for, and downloading, digital compliance material. The digital compliance material describes relevant compliance policies for conveyance of benefits to a benefit recipient. The method also includes applying at least one artificial intelligence model to the downloaded digital compliance material, and determining, from the applying the at least one AI model, at least one compliance policy for conveyance of at least one benefit to the benefit recipient. The method further includes, based on receiving a prompt from a sender desiring to convey a benefit, responding by indicating, for each identified benefit of at least one identified benefit, whether conveyance of the identified benefit complies with the relevant compliance policies for conveyance of benefits to the benefit recipient.

Yet further, a computer program product including a computer readable storage medium readable by a processing circuit and storing instructions for execution by the processing circuit is provided for performing a method. The method automatically searching for, and downloading, digital compliance material. The digital compliance material describes relevant compliance policies for conveyance of benefits to a benefit recipient. The method also includes applying at least one artificial intelligence model to the downloaded digital compliance material, and determining, from the applying the at least one AI model, at least one compliance policy for conveyance of at least one benefit to the benefit recipient. The method further includes, based on receiving a prompt from a sender desiring to convey a benefit, responding by indicating, for each identified benefit of at least one identified benefit, whether conveyance of the identified benefit complies with the relevant compliance policies for conveyance of benefits to the benefit recipient.

Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts further details of an example compliance determination module to incorporate and/or use aspects described herein;

FIG. 3 depicts further details of an example analysis sub-module to incorporate and/or uses aspects described herein;

FIG. 4 depicts an example conceptual diagram for building a compliance collection, in accordance with aspects described herein;

FIG. 5 depicts an example conceptual diagram of using a compliance collection, in accordance with aspects described herein;

FIG. 6 depicts an example process for compliance determinations for conveyance of benefits, in accordance with aspects described herein.

### DETAILED DESCRIPTION

Described herein are approaches for determining compliance as it relates to conveyance of a benefit, sometimes referred to as a ‘corporate engagement’, from a sender of the benefit to a benefit recipient. While corporate gifting platforms exist, they lack adequate insurance that a proposed conveyance of a benefit from a sender to a receiver is compliant with applicable compliance policies to which such a conveyance is subject.

Aspects described herein enable organizations (as one example) to understand and follow regulatory and other compliance rules and mandates while enhancing and building relationships across client engagement life cycles through the act of corporate gifting (used interchangeably herein with ‘conveyance of benefit(s)’). As described, artificial intelligence (AI) may be used at a front-end of a benefit approval queue (referring to assessing compliance prior to conveying the benefit and before the related expense occurs) to facilitate assembly of both a compliance approval and a sender benefit selection into an end-to-end workflow. In example embodiments, AI finds relevant compliance policies through digital compliance materials (documents, articles, regulations, etc.) considered when attempting to convey a benefit to a recipient that is external to the sender's organization. Additionally, the AI can parse through the digital compliance material, for instance the pages of applicable documents, which can range from hundreds to thousands of pages, identify the specific sections in the material that mention and/or pertain to conveyance of benefits, and translate the potentially complex legalese of these sections into relatively simple and easily understandable statements of what the sender can or cannot do with respect to conveying benefits to the benefit recipient, such as a target company or employees/associate of that company. Additionally, the AI may be able to synthesize this output to provide the sender with knowledge of how to compliantly engage with benefit recipients, for example target customers of that sender. By increasing the quality of data evaluated, for example through fetching and parsing of updated digital compliance material, aspects discussed herein help users keep pace with relevant compliance policies, including for example legal documents, legislation, and regulations, that might rapidly change over time. In some examples, the AI is also able to suggest compliant benefits that comport with applicable compliance policies. A user-interface can present, to a sender of a benefit, a list in any desired format to reflect specific benefits and/or benefit types that are compliant (using a green “check” for instance) and to reflect specific benefits and/or benefit types that are non-compliant (using a red “X” for instance). Such benefits might be provided to the benefit recipient by third-party vendors on behalf of the sender/sending company. Example categories of benefits include objects, e.g., as gifts, meals, services, amenities, and entertainment.

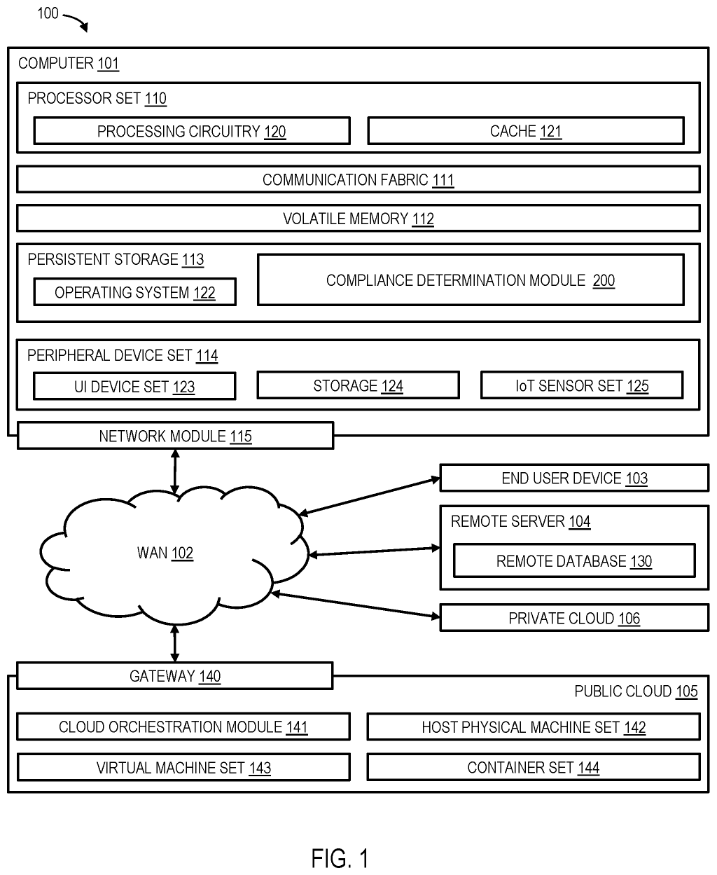

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code of compliance determination module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above in FIG. 1 is only one example of a computing environment to incorporate, perform, and/or use aspect(s) of the present invention. Other examples are possible. For instance, in one or more embodiments, one or more of the components/modules of FIG. 1 are not included in the computing environment and/or are not used for one or more aspects of the present invention. Further, in one or more embodiments, additional and/or other components/modules may be used. Other variations are possible.

Aspects described herein enable a sender, such as a company or employees/associates of that company, to convey, in substance or as an offer, a benefit to a recipient, which might be another company or employee/associate thereof, while remaining compliant with the relevant compliance policies. The benefit might be to send or provide a gift, or offer an amenity to the recipient, as examples. An example of a sending company providing such a benefit could be an employee or other person associated with that company, as a “sender”, conveying the benefit. The recipient of such benefit may be an employee or other person associated with a recipient company, as a receiver/recipient.

In one aspect, digital compliance material is collected from a number of different data sources. Examples include code(s) or guidelines of ethics and/or business conduct, gifting policies, hospitality policies, regulations, news that may be regulatory in nature, and compliance-related data due to industry vertical or jurisdiction/country of the recipient. As an example of this compliance-related data due to industry vertical or jurisdiction/country, certain classes of products may be prohibited from sending in the physical mail or shipping overseas. Other data sources are possible.

In examples, the digital compliance material is in text form and downloaded for analysis using pre-trained models to extract passages and text relevant to conducting business with the recipient, and more specifically compliance surrounding the conveyance of benefits. Examples of these data may include categorical limits placed on various business amenities that a sender may wish to offer, state-by-state, country-by-country, or regulated industry limits in aggregate that should be observed and tracked, and/or new regulations resulting in a change in business status not reflected in company documents but legally binding due to recent court, legislative, or merger activity.

By way of an example embodiment, an employee from a sending company (sender) first selects an individual of a recipient company (benefit recipient) with which the sender wants to engage. An up-to-date record, as determined by searches, of data source locations for the compliance policies relevant to that benefit recipient is maintained. A process determines relevant text portions from this digital compliance material, extracts therefrom answers as to whether particular conveyance are compliant, simplifies and paraphrases the answers into short passages/answers, using natural language understanding (NLU) and/or natural language processing (NLP) model(s), for example, and synthesizes the multiple sources to provide categorical answers (i.e., “Yes”, “No”, or “Conditionally Yes”) using a text similarity model. This can be used to identify and provide a selection of benefits and their assessed level/confidence of compliance for the sender's consideration when desiring to offer a benefit to the benefit recipient.

In addition, aspects can track aggregate spending by the sending company to the recipient, including amounts for each individual as it pertains to legal requirements for their particular company, market, industry, and/or policy as determined to have been described and relevant in the compliance material.

Compliance determination for conveyance of benefits can front-end the approval process to avoid non-compliance. In some examples, the sender need only provide a few fields of information (such as a proposed benefit and a proposed recipient) and select a submit button to invoke compliance determination processing for determining whether conveyance of the proposed benefit complies with the relevant compliance policies. A process collects digital compliance material, in data form, that describes relevant compliance policies for conveyance of benefits to a benefit recipient. Example sources includes relevant codes of ethics/conducts of the recipient, to the extent they exist, which include polices that are directed to the recipient's receipt of benefits as part of the conveyance of benefit from the sender to the recipient. Such benefit recipient compliance policies can dictate/describe acceptable and/or unacceptable conveyances to the recipient. Digital compliance material can also include sender compliance material with polices to which the sender is subject and which are directed to the sender's conveyance of benefits, specifically dictating/describing what is acceptable/unacceptable from the perspective of the sender. Often times digital compliance material is in the form of documents that are available on the official web sites of the sender/recipient and are usually presented in Portable Document Format (PDF) or HypterText Markup Language (HTML) format of varying length (˜5-50 pages).

The compliance material can then be processed to extract relevant text therefrom and this text can be analyzed using NLU/NLP to extract the section(s) from the material indicative of whether proposed benefits are compliant or not compliant with the compliance policies.

Thus, in a first aspect, digital compliance material is gathered. Some or all of the material may be specific to a given recipient or sender. Other material may pertain more broadly to groups of individuals or companies, such politicians, licensed pharmacists, or government-owned organizations.

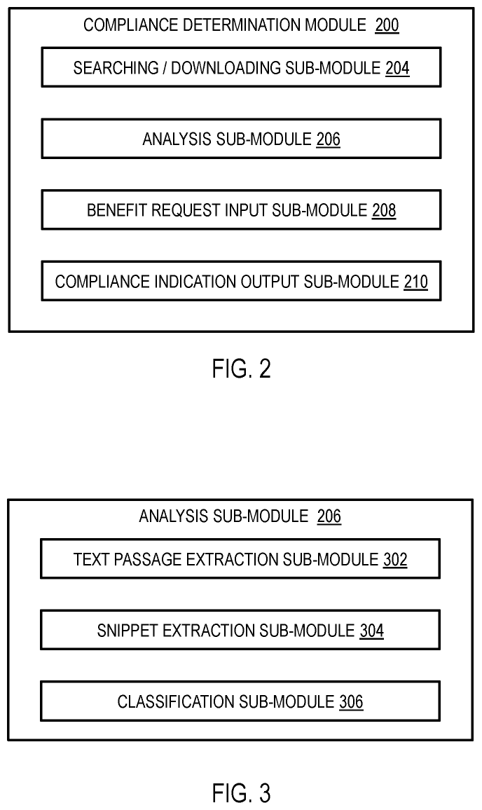

Compliance determination can be invoked by any of varying triggers. In embodiments, aspects described (below) with reference to FIG. 2 are prompted by a sender indicating a desire to convey a benefit to a recipient (company, employee, associate, or other individual). The sender might explicitly identify the recipient, for instance the name of a company or individual, which can be used to tailor compliance determination to conveyance to that particular recipient. As an enhancement, the sender might also indicate a specific benefit (such as a specific luxury watch) or benefit type (for instance “event tickets”), which can be used to perform a more tailored analysis of the compliance material as described herein. Thus, a process might optionally receive from a user/sender an indication of a benefit recipient and optionally receive a specific benefit or benefit type to convey to the benefit recipient. Examples of benefit types include, but are not limited to, meals, entertainment events, gifts, gift cards/certificates, and conference/convention tickets.

In other examples, aspects described with reference to FIG. 2 are initiated not based on a specific sender desiring to convey a benefit at that time but instead as part of an effort to build a compliance collection/database pertaining to an identified one or more potential recipients so that compliance parameters are learned prior to a sender inquiring about compliant benefits. In this manner, a collection of compliance indications for various benefits and/or benefit types and across various benefit recipients could be built by a sender company, for instance to encompass recipients that the sender company anticipates could be a target for benefits by employees/associates of the sender.

FIG. 2 depicts further details of an example compliance determination module (e.g., compliance determination module 200 of FIG. 1) to incorporate and/or use aspects described herein. In one or more aspects, compliance determination module 200 includes, in one example, various sub-modules to be used to perform compliance determination. The sub-modules can be or include, e.g., computer readable program code (e.g., instructions) in computer readable media, e.g., persistent storage (e.g., persistent storage 113, such as a disk) and/or a cache (e.g., cache 121), as examples. The computer readable media may be part of a computer program product and may be executed by and/or using one or more computers or devices, and/or processor(s) or processing circuitry thereof, such as computer(s) 101, EUD 103, server 104, or computers of cloud 105/106 of FIG. 1, as examples.

Referring to FIG. 2, searching and downloading sub-module 204 automatically searches for, and downloads, digital compliance material that describes relevant compliance policies for conveyance of benefits to a benefit recipient. The benefit recipient in this case refers to whatever benefit recipient(s) are subject of the digital compliance material. As noted, the recipient need not be an entity already identified by the sender; it could be one targeted for building compliance indications relative to the specific policies of that recipient. Additionally, or alternatively, this could refer to any recipient of a group or category to which the compliance material applies. For example, the compliance material could be governmental regulations that apply broadly to any government employee.

In some examples, searching and downloading sub-module 204 utilizes a search engine application programming interface (API) to find publicly-available compliance material, such as code of ethics/business conduct guidelines, gift policies, and the like of or pertaining to benefit recipient(s), any relevant recent news which may be regulatory in nature, and any relevant compliance-related data due to industry vertical or country in which the recipient(s) are situated.

Additionally, the relevant compliance material might include compliance material pertaining to a sender company, in which case similar actions can be performed to gather sender compliance material to include in the digital compliance material. For instance, a company might promulgate policies as to how company employees/associates engage with benefit recipients. A sender's own company might enact a policy prohibiting conveyance of gifts valued at over $100, for example, and that is rightly included as a compliance policy for conveyance of a benefit from that company to a benefit recipient.

With the digital compliance material obtained, it can then be analyzed by analysis sub-module 206 of FIG. 2. The material may be processed by the analysis sub-module 206. In general, a process can apply at least one AI model to the downloaded digital compliance material and determine, from that applying, at least one compliance policy for conveyance of at least one benefit to the benefit recipient. One compliance policy might pertain to values of meals, while another compliance policy might pertain to gifting of objects, as examples. In situations where a specific benefit has already been indicated, for instance a sender/user has identified a specific wrist-watch worth $1,000 as a proposed gift to a specific recipient, and this identification has invoked compliance determination processing, then application of the AI model(s) might identify a lone compliance policy that applies and states that only gifts valued at under $100 are allowed. The conclusion is therefore that the proposed benefit (wrist-watch) is non-compliant. In situations where only a benefit type such as ‘meal’, as opposed to a specific benefit such as the $295 tasting menu at a given restaurant, has been specified, or where there is no indication of a benefit or benefit type to tailor the analysis, the AI model(s) might identify several different policies applying to various different benefits and/or benefit types.

Ultimately, a goal may be to extract relevant passages from the compliance material and then to automatically reduce this search text by extracting the relevant text. Queries can then be made against this extracted text, the queries being directed to specific benefits/benefit types, in order to arrive at indications of compliant and non-compliant benefits. Initially, document text can be recognized from the digital compliance material to facilitate analysis thereof. Digital compliance material can exist in various formats such as PDF, Word, HTML, images/scans, etc. and therefore text recognition/conversion may be employed where necessary. An approach for text recognition from documents of various formats is optical character recognition (OCR).

The analysis can also undertake a reduction in search text, for instance utilizing NLU/NLP to extract relevant compliance policies/rules and the types of benefits that may be used for engagements. This can be done as part of a filtering-out of what the sender can offer, pursuant to the compliance material, when conveying benefit(s) to the recipient, and the extracted text can be indicated back to the sender, for example in a brief summary. AI may be able to synthesize a simple sentence or phrase from a complete data set, for instance, enabling senders to easily understand compliant and non-compliant benefits.

By way of specific example, an NLU model can accept queries and extract answers from the extracted text. The following is an example pattern for an NLU query: “Can [benefit recipient] employees accept [benefit/benefit type]?” Any amount limits in the extracted text, such as the maximum spend on a meal, can be extracted using pattern matching with regular expressions, for instance.

Text extracted from digital compliance material documents can be of various length. Example lengths are 2 to 50 or more pages. Consequently, as mentioned above, it may be desired to reduce the search content, for instance using a NLU-based passage retrieval model. Example such models take a question and document text as inputs. For instance, an example question may be “Is an employee of company C allowed to conduct an action XYZ?”, where C and XYZ are replaced with a real company name and a real action/action type. An example document text might be text recognized/extracted from the compliance material. A process can feed the question and document text to the passage retrieval model, which then will conduct a search of the document text and return passages/sections therefrom that relate to the question. Additionally, the retrieval model can provide a confidence level for each returned result, the confidence indicative of the model's confidence in an answer desired from the result. Sections with low confidence can be filtered out if desired. A threshold could be set manually, for instance. An example such threshold is in the range of 70%-75%, where if the retrieval model indicates a confidence level less than the threshold for a section, then that section is not considered relevant enough.

For instance, assume that recognized text from digital compliance material put forth by company C has a word count of 17,500. A query as to whether an employee of company C can accept meals as a benefit might return a relevant passage of 295 words that lists classes of benefits and qualifications as to which of those are proper to accept, factors to consider when assessing compliance, and other guidelines. Referring to FIG. 3, which depicts further details of an example analysis sub-module (e.g., analysis sub-module 206) to incorporate and/or use aspects described herein, text passage extraction can be performed by text passage extraction sub-module 302. Further extraction can reduce this amount of text (e.g., 295 words) even more. For instance, an NLU and/or NLP-based short question and answer model can be utilized to find short ‘answers’ from these already-pruned passages. The inputs for such a model can again be a question and a passage (such as the 295 word passage). In this manner, a snippet extraction sub-module 304 (FIG. 3) can use NLU and/or NLP to reduce extracted text passages to extracted answer text snippets, where each extracted answer text snippet indicates, for a respective specific benefit and/or a specific benefit type, whether conveyance of the selected specific benefit or selected benefit type complies with the relevant compliance policies. The phrase “only gifts valued at under $1,000 are acceptable” is an example such answer text snippet than can be extracted and inform a policy on gifts. This particular language can be used to understand that gifts valued under $1,000 are compliant, at least insofar as this clause is concerned, while gifts valued at $1,000 or greater are non-compliant.

Using the NLU in this scenario can include providing to an NLU model queries tailored to specific benefits and specific benefit types, where the NLU model extracts the answer text snippets based on the queries. The NLU model can then provide, as responses to the queries, the extracted answer text snippets. For instance, an example question posed is “Is employee of company A allowed or prohibited to conduct an action XYZ?” and the corresponding text passage that is provided with the question can be the 295-word passage previously extracted as discussed above. The process feeds the question and passage into the model, which responds with a relatively short answer/snippet of text. By way of example, a snippet returned might be the text “modest, infrequent, and unreciprocated” in reference to receipt of meals, in which the foregoing provide characterizations informing whether conveyance of a meal to a recipient subject to this policy is compliant or non-compliant with this policy.

Since these extracted short answers can be sometimes ambiguous or difficult for the average user to apply to a selected benefit due to the complexity and specialized nature of legal language, aspects (e.g., classification sub-module 306) can classify these answer text snippets into classes for easier understanding. For instance, aspects can classify an extracted answer text snippet into (i) a class indicating that the selected specific benefit or specific benefit type for that extracted answer text snippet is compliant with the relevant compliance policy, (ii) a class indicating that the selected specific benefit or specific benefit type for that extracted answer text snippet is compliant with the relevant compliance policies provided additional conditions are satisfied, or (iii) a class indicating that the respective selected specific benefit or specific benefit type for that extracted answer text snippet is non-compliant with the relevant compliance policies. In examples, this may be accomplished using a text similarity model to match the answer to one of the three categories corresponding to the above three options: ‘non-compliant’ (No), ‘compliant’ (yes), or ‘compliant only if . . . ’ (Conditional). An example text similarity model takes an input sentence (such as an extracted answer text snippet) and a list of sentences to match the input. By way of example, take the input sentence to be the snippet above, i.e., “modest, infrequent, and unreciprocated” in reference to receipt of meals, and the pre-programed list of sentences to be “Employee of Company A is allowed to conduct XYZ” (yes/compliant), “Employee of Company A is prohibited to conduct XYZ” (no/non-compliant), and “Employee of Company A is allowed to conduct XYZ if certain conditions are met” (compliant only if/conditional). The process can compare the input sentence to the list of pre-programmed sentences using the text similarity model and select the class to be the option with the highest similarity. If the answer/class is non-compliant for the benefit/benefit type, for instance, then the conveyance is non-compliant.

Thus, based on receiving (via input to a benefit request input sub-module 208 of the compliance determination module 200, for instance) a prompt from a sender desiring to convey a benefit, whether specifically identified or left unspecified, a process can respond by indicating, for each of one or more identified benefits, whether conveyance of the identified benefit complies with the relevant compliance policies for conveyance of benefits to the benefit recipient. The indication can be provided (for example via compliance indication output sub-module 210 of the compliance determination module 200, see FIG. 3) as the output of information to the prospective sender in a graphical user interface on a computer system. In examples, the sender loads a system/interface that enables input for potential selection of benefits for conveyance. Benefit request input sub-module 208 can provide such an interface. Aspects (such as compliance indication output sub-module 210) can additionally generate and present in the user interface summary statements for display to the user, where each of the summary statements provide a one-sentence/phrase distillation of one or more extracted answer text snippets in a user-understandable form. Legalese, complexity in the words used, arrangement of words, and other properties of the compliance material might make the extracted language difficult to understand. NLU/NLP can be used to rephrase or rewrite the policies indicated by the extracted snippets into ‘layman's terms’, e.g., more easily understood, straightforward, distilled summary statements as to what is acceptable and unacceptable.

In some situations, for instance ones where the sender has not identified a specific benefit but, perhaps, has identified a type of benefit, a process can generate, and an interface can present, a filtered list of compliant benefit options based on the above analysis of compliance material. Compliant benefit options means benefits for which conveyance has been confidently determined to comply with the relevant compliance policies. Confidently determined means that the level of confidence meets/exceeds some threshold. The list of these distinctive benefits can be presented together with tags that categorize the benefits by unique classes, or instance benefit type, level of compliance (e.g., quantitative measure of the confidence in the compliance determination) with the relevant compliance policies, and/or location, as examples. Tags can be merged with information known about the recipient, for instance notes about hobbies, likes/dislikes, dietary restrictions, and other data about what benefits have historically been most well received by other recipients in the same or similar geography, recipient company, and/or industry, for instance. The tags can also facilitate easy sorting and filtering of the list, if desired.

The prompt from the sender could, whether identifying any specific benefit recipient or not, prompt the automatically searching for, and downloading, the digital compliance material, the analyzing, and the responding to be performed. In embodiments, the prompt from the sender encompasses a plurality of benefit recipients. For instance, a sender might wish to browse compliant benefits for conveyance to the sender's collection of customers, as potential recipients. In these situations, the automatic searching for, and downloading, of digital compliance material can target material relevant any/all of that plurality of benefit recipients, and the applying the AI model(s) can be performed for each of the plurality of benefit recipients, e.g., to consider compliance determinations relative to each individual recipient. Responding with compliance indications can indicate, for each of the plurality of benefit recipients, a respective one or more identified benefits for which conveyance is confidently determined to comply with the relevant compliance policies for conveyance of benefits to that benefit recipient.

Compliance indications can be stored in a compliance collection/database if desired for potential later use. For instance, a process could refer to the collection in response to a sender user providing a prompt to browse compliant benefits for possible conveyance. A user might select a specific gift and target recipient, and a process could look into the collection to see whether there is a cached indication of compliance/non-compliance relative to that gift and recipient. The collection might be periodically or aperiodically updated as desired, since compliance policies could change over time.

For compliance benefits, the sender, interacting with the system, can create an approval request record for possible review/approval by another entity, if required. Such a record could include a context of the conveyance and a justification, if desired. Thus, based on the sender selecting a benefit for conveyance to a benefit recipient, a process can build a request data record that includes a context of sender selection, where the context includes results of the applying the AI model(s) and optionally provides the support for the determination, i.e., the determined compliance policy/policies that were used to arrive at the results. The results can include the various intermediate results of the AI model/analysis processing.

In some embodiments, for instance if there are no exceptions or flags raised by the analysis, then the benefit request is automatically approved insofar as compliance is concerned. It is noted that the request might still go to a manager or other entity for approval/denial based on other considerations not part of the compliance determination. Instead, if there are exception or flags, for instance perhaps the compliance determination was provided by with a low (i.e., below some predefined threshold confidence), then the request can be sent on to an approval queue.

These aspects shift the compliance determination process to a time prior to conveyance of the benefit. This contrasts with many current approaches that consider appropriateness of a conveyance at an expense approval stage after conveyance has occurred. By shifting the compliance inquiry ahead of the conveyance, this proactively prevents problematic conveyances from occurring.

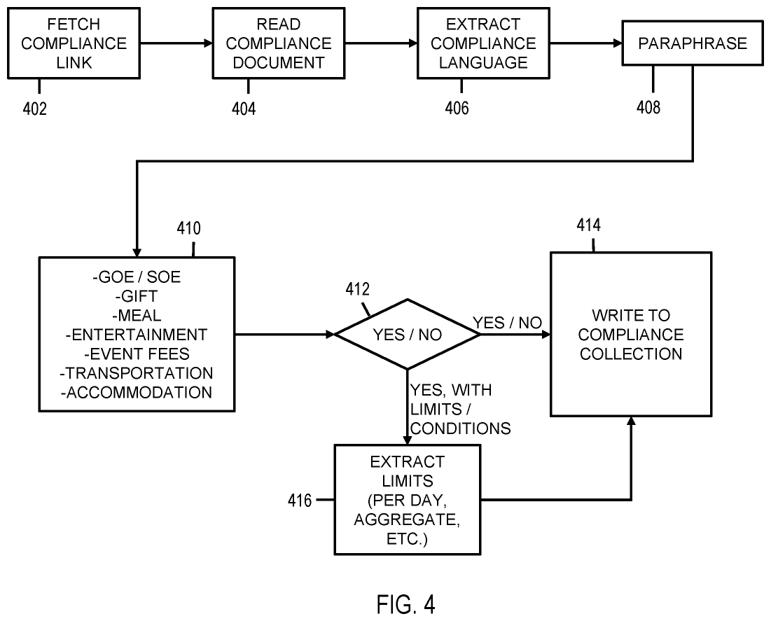

FIG. 4 depicts an example conceptual diagram for building a compliance collection, in accordance with aspects described herein. The building could be performed by a compliance determination module (e.g., module 200), for instance. The building fetches (402) links to digital compliance material, reads (404) the compliance material, extracts compliance language (406), and paraphrases (408) the compliance language in an effort to understand the compliance policies and classifications (410) for particular benefits/benefit types, in terms of compliance or non-compliance. Non-compliant items (412, NO) can be written (414) as indications in the compliance collection, as can compliant items (412, Yes). If there are limits (or conditions) to a compliant benefit (412, YES WITH LIMITS/CONDITIONS), then these can be extracted (416) and indications of both the limits (or conditions) and the conditional compliance can be written (414) to the compliance collection.

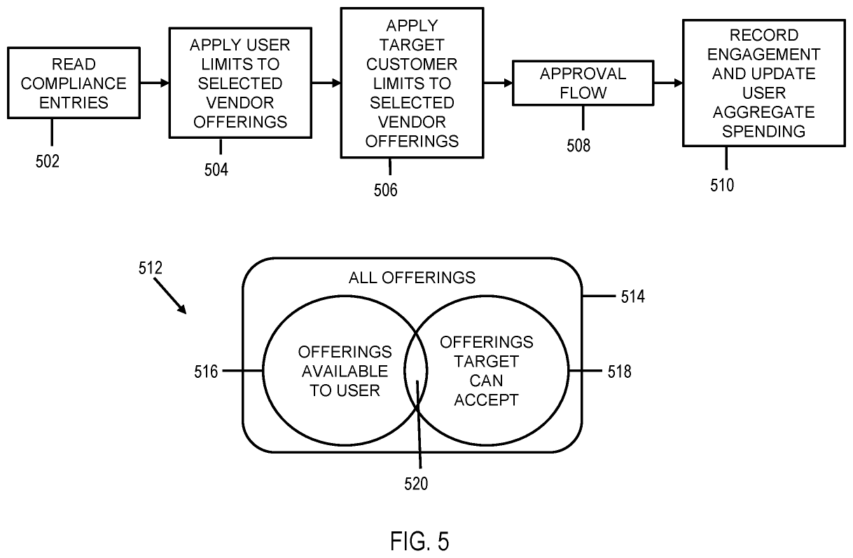

The building performed in accordance with aspects of FIG. 4 can be performed pursuant to a user/sender request or could be performed unprompted by any such user/sender request. In this manner, a compliance collection could be built proactively to be later used based on submission by a sender of an inquiry/request regarding conveyance of one or more benefits. FIG. 5 depicts an example conceptual diagram of using a compliance collection, in accordance with aspects described herein. The use in this example incorporates consideration as to what is compliant/available for the sender to convey at the time of the requested conveyance and applicable limits (e.g., spending/receiving limits) to which the sender/recipient are subject. In this example, a sender/user has identified a target customer (recipient). The process reads (502) the compliance entries to identify compliant offerings (benefits) of a vendor and applicable limits. The user has selected offerings and the process applies (504) user limits to those selected offerings, and applies (506) target customer limits to those selected offerings. The proposed conveyance of these offerings then is passed to the approval flow (508) and, assuming the engagement is approved, then this engagement is recorded and the user aggregated spending is updated (510).

512 presents an illustration of the relation between all offerings (514) available from a benefit vendor, offerings (516) that are available for the user to potentially convey, and offerings (518) that the target customer can accept. The overlap (520) of 516 and 518 represents the acceptable/compliant offerings for conveyance from the user/sender to the recipient.

Aspects described herein provide benefits over other approaches, for instance those that rely exclusively on user discretion for compliance determination, e.g., without AI, and/or that require user manual input of compliance rules. Often in other approaches the onus is on the user sending the benefit to know this information. In contrast, aspects described herein leverage AI to collect and interpret all appropriate compliance information regarding target recipients and the sender as a prerequisite to allowing conveyances of benefits.

Some example advantages provided by aspects described herein include:
Finding and collecting digital compliance material automatically, which documents contain rules on corporate gifting compliance that are normally time consuming to both locate and read;
Using AI to check whether sending benefits to clients/customers is permissible, prohibited, or if some restrictions apply;
Helping prevent situations of accidental bribery scenarios;
Simplifying potentially complex and confusing compliance policies by using categorical, unambiguous results including binary or multi-category (i.e., “Yes” or “No”, or “Compliant”, “Not Compliant”, “Compliant only if . . . ”, etc. designations;
Improving the models over time to achieve better performance by collecting feedback from end users and feeding this into AI model(s) used at various steps;
Clarifying and presenting only relevant compliance material text and providing a categorical response on click or hover (over a benefit indicated in the user interface, for instance)

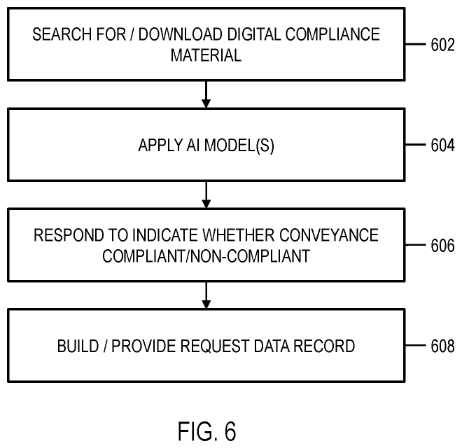

FIG. 6 depicts an example process for compliance determinations for conveyance of benefits, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 6 are part of a module, such as module 200. In other examples, the code may be included in one or more modules and/or in one or more sub-modules of the one or more modules. Various options are available.

The process automatically searches for, and downloads (602), digital compliance material. The digital compliance material describes relevant compliance policies for conveyance of benefits to a benefit recipient. In examples, the digital compliance material includes any one or more of: code(s) or guidelines of ethics and/or business conduct, gifting policies, hospitality policies, digital news information informing of a category of recipients to which the benefit recipient belongs, and which category of recipients is subject to at least some of the relevant compliance policies, and governmental regulations setting forth at least some of the relevant compliance policies.

The process applies (604) at least one artificial intelligence (AI) model to the downloaded digital compliance material, and determines, from the applying the at least one AI model, at least one compliance policy for conveyance of at least one benefit to the benefit recipient. In examples, the applying the at least one AI model includes (i) analyzing the digital compliance material with at least one pre-trained model configured to extract text passages, from the digital compliance material, that are relevant to the conveyance of benefits to the benefit recipient, and (ii) extracting from the digital compliance material the text passages that are relevant to the conveyance of benefits to the benefit recipient. The applying the at least one AI model can further include using NLU and/or NLP to reduce the extracted text passages to extracted answer text snippets. Each extracted answer text snippet can indicate, for a specific benefit (or a specific benefit type), whether conveyance of the selected specific benefit (or selected benefit type) complies with the relevant compliance policies. In some embodiments, using the NLU and/or NLP uses NLU and includes (i) providing to an NLU model queries tailored to specific benefits and specific benefit types, the NLU model extracting the answer text snippets based on the queries, and (ii) receiving from the NLU model, as responses to the queries, the extracted answer text snippets. In embodiments, the process also includes classifying an extracted answer text snippet into one of the following classes: (i) a class indicating that the respective selected specific benefit or specific benefit type for that extracted answer text snippet is compliant with the relevant compliance policies, (ii) a class indicating that the respective selected specific benefit or specific benefit type for that extracted answer text snippet is compliant with the relevant compliance policies provided additional conditions are satisfied, or (iii) a class indicating that the respective selected specific benefit or specific benefit type for that extracted answer text snippet is non-compliant with the relevant compliance policies.

In yet further embodiments, the process can generate summary statements for display to a user, where each of the summary statements provides a one-sentence/phrase distillation of one (or more) of the extracted answer text snippets in a user-understandable form. As an example, the summary statement can be a reworded, rephrased, and/or explanatory statement in a more easily understandable or comprehensible form, for instance in ‘layman's’ terms, as opposed to the potentially confusing or more difficult to understand language of the compliance material.

Continuing with FIG. 6, based on receiving a prompt from a sender desiring to convey a benefit, the process responds (606) by indicating, for each identified benefit of at least one identified benefit, whether conveyance of the identified benefit complies with the relevant compliance policies for conveyance of benefits to the benefit recipient. An example benefit recipient is or includes (i) a target company, (ii) an employee of a target company, or (iii) an associate of a target company. The digital compliance material can include benefit recipient compliance material, i.e., material having polices directed to receiving benefits, for instance a code of ethics, a code of conduct, a gifting policy, and/or a hospitality policy of the benefit recipient, for example. An example sender is or includes (i) a sending company, (ii) an employee of a sending company, or (iii) an associate of a sending company. The digital compliance material can include sender compliance material, i.e., material having polices directed to conveying benefits, for instance a code of ethics, a code of conduct, a gifting policy, and/or a hospitality policy of the sender, for example.

The process of FIG. 6 also includes, based on the sender selecting a benefit for conveyance to the benefit recipient, the benefit confidently determined to comply with the relevant compliance policies for conveyance of benefits to the benefit recipient, building (608) a request data record that includes a context of sender selection. The context can include results of the applying the at least one AI model, including the determined at least one compliance policy.

The prompt could be received at any of various times relative to the aspects of FIG. 6. For instance, the process could have initially received the prompt from the sender, which prompt identifies the benefit recipient, and the automatically searching for, and downloading (602), the analyzing (604), and the responding (608) could be performed in response to that receipt of the prompt. In embodiments, the at least one identified benefit (as part of the responding 606) is a specific benefit indicated by the prompt, and the responding (606) indicates whether conveyance of that specific benefit to the identified benefit recipient complies with the relevant compliance policies for conveyance of benefits to that identified benefit recipient. Alternatively, the at least one identified benefit (as part of the responding 606) could include a plurality of identified benefits for which conveyance is confidently determined to comply with the relevant compliance policies, and the responding (606) could include generating and presenting an interface having a list of distinctive benefits from which the sender can select, the list of distinctive benefits presented together with tags categorizing the benefits by a plurality of unique classes, the unique classes comprising at least one selected from the group consisting of: benefit type, level of compliance with the relevant compliance policies, and location.

The prompt from the sender could encompass a plurality of benefit recipients. The automatically searching for, and downloading (602), digital compliance material and the applying (604) the AI model(s) could therefore be performed for each of the plurality of benefit recipients, and the responding (606) could indicate, for each of the plurality of benefit recipients, a respective plurality of identified benefits for which conveyance is confidently determined to comply with the relevant compliance policies for conveyance of benefits to that benefit recipient. In this manner, a selection of benefits could be provided for each of several recipients, the selection corresponding to each recipient being benefits that are compliant for conveyance.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
automatically searching for, and downloading, digital compliance material, the digital compliance material describing relevant compliance policies for conveyance of benefits to a benefit recipient;
applying at least one artificial intelligence (AI) model to the downloaded digital compliance material, and determining, from the applying the at least one AI model, at least one compliance policy for conveyance of at least one benefit to the benefit recipient; and
based on receiving a prompt from a sender desiring to convey a benefit, responding by indicating, for each identified benefit of at least one identified benefit, whether conveyance of the identified benefit complies with the relevant compliance policies for conveyance of benefits to the benefit recipient.

2. The method of claim 1, wherein the benefit recipient comprises at least one selected from the group consisting of: a target company, an employee of a target company, and an associate of a target company, and wherein the digital compliance material comprises benefit recipient compliance material having polices directed to receiving benefits, the benefit recipient compliance material comprising at least one selected from the group consisting of: a code of ethics, a code of conduct, a gifting policy, and a hospitality policy of the benefit recipient.

3. The method of claim 1, wherein the sender comprises at least one selected from the group consisting of: a sending company, an employee of a sending company, and an associate of a sending company, and wherein the digital compliance material comprises sender compliance material having polices directed to conveying benefits, the sender compliance material comprising at least one selected from the group consisting of: a code of ethics, a code of conduct, a gifting policy, and a hospitality policy of the sender.

4. The method of claim 1:
wherein the benefit recipient comprises at least one selected from the group consisting of: a target company, an employee of a target company, and an associate of a target company, wherein the digital compliance material comprises benefit recipient compliance material having polices directed to receiving benefits, the benefit recipient compliance material comprising at least one selected from the group consisting of: a code of ethics of the benefit recipient, a code of conduct of the benefit recipient, a gifting policy of the benefit recipient, and a hospitality policy of the benefit recipient;
wherein the sender comprises at least one selected from the group consisting of: a sending company, an employee of a sending company, and an associate of a sending company, and wherein the digital compliance material comprises sender compliance material having polices directed to conveying benefits, the sender compliance material comprising at least one selected from the group consisting of: a code of ethics of the sender, a code of conduct of the sender, a gifting policy of the sender, and a hospitality policy of the sender; and
wherein whether conveyance of the identified benefit complies with the relevant compliance policies is based at least in part on compliance with both (i) the benefit recipient compliance material and (ii) the sender compliance material.

5. The method of claim 1, wherein the digital compliance material comprises at least one selected from the group consisting of:
digital news information informing of a category of recipients to which the benefit recipient belongs, and which category of recipients is subject to at least some of the relevant compliance policies; and
governmental regulations setting forth at least some of the relevant compliance policies.

6. The method of claim 1, wherein the applying the at least one AI model comprises:
analyzing the digital compliance material with at least one pre-trained model configured to extract text passages, from the digital compliance material, that are relevant to the conveyance of benefits to the benefit recipient; and
extracting from the digital compliance material the text passages that are relevant to the conveyance of benefits to the benefit recipient.

7. The method of claim 6, wherein the applying the at least one AI model further comprises using at least one selected from the group consisting of natural language understanding (NLU) and natural language processing (NLP) to reduce the extracted text passages to extracted answer text snippets, each extracted answer text snippet indicating, for a respective one selected from the group consisting of a specific benefit and a specific benefit type, whether conveyance of the selected specific benefit or selected benefit type complies with the relevant compliance policies.

8. The method of claim 7, wherein the using the selected at least one of NLU and NLP comprises providing to an NLU model queries tailored to specific benefits and specific benefit types, the NLU model extracting the answer text snippets based on the queries, and receiving from the NLU model, as responses to the queries, the extracted answer text snippets.

9. The method of claim 7, further comprising classifying an extracted answer text snippet into one class selected from the group consisting of:
a class indicating that the respective selected specific benefit or specific benefit type for that extracted answer text snippet is compliant with the relevant compliance policies;
a class indicating that the respective selected specific benefit or specific benefit type for that extracted answer text snippet is compliant with the relevant compliance policies provided additional conditions are satisfied; and
a class indicating that the respective selected specific benefit or specific benefit type for that extracted answer text snippet is non-compliant with the relevant compliance policies.

10. The method of claim 7, further comprising generating summary statements for display to a user, each of the summary statements providing a respective one-sentence distillation of one or more extracted answer text snippets in a user-understandable form.

11. The method of claim 1, further comprising receiving the prompt from the sender, the prompt identifying the benefit recipient, wherein the automatically searching for, and downloading, the digital compliance material, the analyzing, and the responding are performed in response to the receiving the prompt.

12. The method of claim 11, wherein the at least one identified benefit is a specific benefit indicated by the prompt, and wherein the responding indicates whether conveyance of that specific benefit to the identified benefit recipient complies with the relevant compliance policies for conveyance of benefits to that identified benefit recipient.

13. The method of claim 11, wherein the at least one identified benefit comprises a plurality of identified benefits for which conveyance is confidently determined to comply with the relevant compliance policies, and wherein the responding comprises generating and presenting an interface having a list of distinctive benefits from which the sender can select, the list of distinctive benefits presented together with tags categorizing the benefits by a plurality of unique classes, the unique classes comprising at least one selected from the group consisting of: benefit type, level of compliance with the relevant compliance policies, and location.

14. The method of claim 1, wherein the prompt from the sender encompasses a plurality of benefit recipients, wherein (i) the automatically searching for, and downloading, digital compliance material and (ii) the applying the at least one AI model are performed for each of the plurality of benefit recipients, and wherein the responding indicates, for each of the plurality of benefit recipients, a respective plurality of identified benefits for which conveyance is confidently determined to comply with the relevant compliance policies for conveyance of benefits to that benefit recipient.

15. The method of claim 1, further comprising, based on the sender selecting a benefit for conveyance to the benefit recipient, the benefit confidently determined to comply with the relevant compliance policies for conveyance of benefits to the benefit recipient, building a request data record that includes a context of sender selection, the context including results of the applying the at least one AI model, including the determined at least one compliance policy.

16. A computer system comprising:
a memory; and
a processor in communication with the memory, wherein the computer system is configured to perform a method comprising:
automatically searching for, and downloading, digital compliance material, the digital compliance material describing relevant compliance policies for conveyance of benefits to a benefit recipient;
applying at least one artificial intelligence (AI) model to the downloaded digital compliance material, and determining, from the applying the at least one AI model, at least one compliance policy for conveyance of at least one benefit to the benefit recipient; and
based on receiving a prompt from a sender desiring to convey a benefit, responding by indicating, for each identified benefit of at least one identified benefit, whether conveyance of the identified benefit complies with the relevant compliance policies for conveyance of benefits to the benefit recipient.

17. The computer system of claim 16, wherein the applying the at least one AI model comprises:
analyzing the digital compliance material with at least one pre-trained model configured to extract text passages, from the digital compliance material, that are relevant to the conveyance of benefits to the benefit recipient;
extracting from the digital compliance material the text passages that are relevant to the conveyance of benefits to the benefit recipient; and
using at least one selected from the group consisting of natural language understanding (NLU) and natural language processing (NLP) to reduce the extracted text passages to extracted answer text snippets, each extracted answer text snippet indicating, for a respective one selected from the group consisting of a specific benefit and a specific benefit type, whether conveyance of the selected specific benefit or selected benefit type complies with the relevant compliance policies.

18. The computer system of claim 16, wherein the method further comprises receiving the prompt from the sender, the prompt identifying the benefit recipient, wherein the automatically searching for, and downloading, the digital compliance material, the analyzing, and the responding are performed in response to the receiving the prompt, wherein the at least one identified benefit comprises a plurality of identified benefits for which conveyance is confidently determined to comply with the relevant compliance policies, and wherein the responding comprises generating and presenting an interface having a list of distinctive benefits from which the sender can select, the list of distinctive benefits presented together with tags categorizing the benefits by a plurality of unique classes, the unique classes comprising at least one selected from the group consisting of: benefit type, level of compliance with the relevant compliance policies, and location.

19. The computer system of claim 16, wherein the method further comprises, based on the sender selecting a benefit for conveyance to the benefit recipient, the benefit confidently determined to comply with the relevant compliance policies for conveyance of benefits to the benefit recipient, building a request data record that includes a context of sender selection, the context including results of the applying the at least one AI model, including the determined at least one compliance policy.

20. A computer program product comprising:
a computer readable storage medium readable by a processing circuit and storing instructions for execution by the processing circuit for performing a method comprising:
automatically searching for, and downloading, digital compliance material, the digital compliance material describing relevant compliance policies for conveyance of benefits to a benefit recipient;
applying at least one artificial intelligence (AI) model to the downloaded digital compliance material, and determining, from the applying the at least one AI model, at least one compliance policy for conveyance of at least one benefit to the benefit recipient; and
based on receiving a prompt from a sender desiring to convey a benefit, responding by indicating, for each identified benefit of at least one identified benefit, whether conveyance of the identified benefit complies with the relevant compliance policies for conveyance of benefits to the benefit recipient.
